(19) United States
(12) Patent Application Publication
(10) Pub. No.: US 2007/0245234 A1
(43) Pub. Date: Oct. 18, 2007

(54) Method and system for outputting calendar by using mobile device

(75) Inventor: Seong-ig Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/709,735

(22) Filed: Feb. 23, 2007

Related U.S. Application Data
(60) Provisional application No. 60/791,411, filed on Apr. 13, 2006.

(30) Foreign Application Priority Data
May 12, 2006 (KR) 2006-43134

(51) Int. Cl. G06F 17/00

(52) U.S. Cl. 715/513

(57) ABSTRACT

A method and system for outputting a calendar by using a mobile device comprises generating XHTML data of the calendar by using XHTML templates defining a layout of the calendar and transmitting the generated XHTML data to an image forming device, and analyzing the transmitted XHTML data and outputting the calendar. As a result, a user can easily output the calendar by using a Markup language such as XHTML-Print data capable of designating a style in the mobile device.

### CROSS-REFERENCE TO RELATED APPLICATIONS

This application claims all benefits accruing under 35 U.S.C. §120 from U.S. Provisional Patent Application No. 60/791,411, filed on Apr. 13, 2006, in the US Patent and Trademark Office, and all benefits accruing under 35 U.S.C. §119 from Korean Patent Application No. 2006-43134, filed on May 12, 2006, in the Korean Intellectual Property Office, the disclosures of which are incorporated herein by reference.

### BACKGROUND OF THE INVENTION

1. Field of the Invention

The present invention relates to an electronic calendar, and more specifically, relates to a method and system for outputting a calendar in which a specific date is distinguished from other dates using a language that can designate a style, such as XHTML-Print data, using a mobile device, when such a mobile device outputs the calendar, via an image forming device, such as a printer.

2. Related Art

As mobile devices, such as mobile phones, have become widely accepted and commonly used to capture, store and/or send digital images, and as image resolutions of those mobile devices continues to improve in ways that are similar to digital still cameras, consumers have come to expect the imaging and printing industry to deliver mobile printing solutions that are simple and reliable for printing at home. For example, a user will want to print a photo from a mobile device, such as a mobile phone, in a simple format. However, owing to the development of device technology, the mobile device provides the user with contents, such as extensible hyper text markup language (XHTML)-Print data that can constitute a variety of layouts and various kinds of information.

The Mobile Imaging & Printing Consortium (MIPC), which is a neutral, non-profit organization that drives mobile printing guidelines across the hardware, software and wireless industries, has discussed various technologies that can utilize functions between a mobile device, such as a mobile phone and an image forming device, such as a printer. The functions of the mobile device and the printer can become complex, since these device must address limitations in terms of power of a CPU and various hardware/software resources. For example, the mobile device must have a certain minimum processing power, and the printer must have more processing power than the mobile device.

In particular, if a user designates a layout of his/her calendar and selects options (year, month, day, etc.) of the calendar using a specific application, a host computer, such as a desktop or laptop computer, can output the calendar using the application and provide a visual display of the calendar on a screen. If the user selects a print menu to print the calendar displayed on the screen, calendar data is converted into printer description language (PDL) data through a printer driver installed in the host computer, and the converted PDL data is transmitted to the printer, so that the printer can output and print the calendar using an emulation and engine.

However, since the mobile device, such as the cellular phone has lower processing power and resources than the host computer, it is difficult to install the printer driver provided by the printer, in the mobile device to print the calendar. Moreover, since the printer driver is dependent on a specific type of printer, the mobile device must install all types of printer drivers so as to use various types of printers available in the market. Unfortunately, in contrast to resources available to the host computer, a mobile device is limited in terms of hardware/software resources and user interface (UI). As a result, such a mobile device cannot provide the user with services such as outputting a calendar in the same manner as the host computer.

### SUMMARY OF THE INVENTION

Several aspects and example embodiments of the present invention provide a method and system for outputting a calendar using a mobile device that can easily output the calendar using a Markup language that can designate a style, such as XHTML-Print data.

Additional aspects and/or advantages of the invention will be set forth in part in the description which follows and, in part, will be obvious from the description, or may be learned by practice of the invention.

In accordance with an example embodiment of the present invention, there is provided a method for outputting a calendar by using a mobile device. Such a method comprises: generating XHTML data of the calendar by using XHTML templates defining a layout of the calendar and transmitting the generated XHTML data to an image forming device, and analysing the transmitted XHTML data and outputting the calendar.

According to an aspect of the present invention, the method further comprises receiving layout setting information about the calendar; and detecting an XHTML template corresponding to the layout setting information and generating the XHTML data corresponding to the received layout setting information before transmission to the image forming device, via the transmission link.

According to an aspect of the present invention, the layout setting information includes at least one of country information, output size information, output kind information, output time information, anniversary output information, text output information, and insert image information.

According to another aspect of the present invention, the method further comprises: selecting to output the calendar; setting the country information, the output size information, the output kind information, the output time information, the anniversary output information, the text output information, and the insert image information; and storing the information as layout setting information of the calendar.

According to an aspect of the present invention, the country information can be automatically set using country code information set in the mobile device.

According to another aspect of the present invention, the XHTML data may be generated by detecting national holiday information corresponding to the country information; and distinguishing the detected national holiday information from other output information of the calendar. Alternatively, the XHTML data may be generated by detecting an insert image corresponding to the insert image information; and including the detected insert image therein.

According to another aspect of the present invention, the method further comprises: registering anniversary information; detecting the registered anniversary information; and generating XHTML data including the detected anniversary information. In addition, text information relating to the anniversary is included as the registered anniversary information.

In accordance with another example embodiment of the present invention, there is provided a system for outputting an calendar by using a mobile device, comprising: a mobile device arranged to generate XHTML data of the calendar by using XHTML templates defining a layout of the calendar; and an image forming device coupled to receive the XHTML data transmitted from the mobile device, analyze received XHTML data and output the calendar.

According to an aspect of the present invention, the mobile device comprises a national holiday storage unit to store national holiday information of each country; an XHTML template information storage unit to store XHTML template information corresponding to various layouts; a user interface unit arranged to receive layout setting information about the calendar; an XHTML data generation unit to detect an XHTML template corresponding to the received layout setting information and generate XHTML data corresponding to the received layout setting information; and a data transmission unit arranged to transmit the generated XHTML data to the image forming device, via a transmission link.

According to an aspect of the present invention, the layout setting information includes at least one of country information, output size information, output kind information, output time information, anniversary output information, text output information, and insert image information.

According to a further aspect of the present invention, the system is further provided with a country information acquisition unit arranged to acquire the country information from country code information set in the mobile device; and an insert image storage unit to store images to be inserted into the calendar, wherein the XHTML data generation unit detects an insert image corresponding to the insert image information from the insert image storage unit, and generates XHTML data including the detected insert image.

According to an aspect of the present invention, the XHTML data generation unit detects national holiday information corresponding to the country information from the national holiday information storage unit, and generates XHTML data including the detected national holiday information.

According to a further aspect of the present invention, the system is further provided with an anniversary information registration unit arranged to register anniversary information; and an anniversary information storage unit to store the registered anniversary information, wherein the XHTML data generation unit detects the registered anniversary information from the anniversary information storage unit, and generates XHTML data including the detected anniversary information.

According to an aspect of the present invention, the XHTML data generation unit generates the XHTML data to distinguish the registered anniversary information from other output information of the calendar.

In accordance with yet another example embodiment of the present invention, a mobile device for generating a calendar comprises a storage unit arranged to store anniversary information input by a user, national holiday information of each country, XHTML-print template information corresponding to various layouts; and images to be inserted into the calendar; a user interface unit arranged to receive layout setting information about the calendar; and a control unit configured to detect an XHTML template corresponding to received layout setting information, to generate XHTML data of the calendar corresponding to the received layout setting information, and to transmit the XHTML data to an image forming device, via a transmission link.

According to an aspect of the present invention, the image forming device is coupled to receive and analyze the XHTML data transmitted from the mobile device, so as to output and print the calendar.

According to an aspect of the present invention, the storage unit comprises: a national holiday storage unit to store national holiday information of each country; an XHTML template information storage unit to store XHTML template information corresponding to various layouts; and an insert image storage unit to store images to be inserted into the calendar, wherein the control unit is further configured to detect an insert image corresponding to the insert image information from the insert image storage unit, and to generate XHTML data including the detected insert image.

According to an aspect of the present invention, the control unit is further configured to acquire the country information from country code information set in the mobile device, to detect national holiday information corresponding to the country information, and to generate XHTML data including the detected national holiday information.

According to another aspect of the present invention, the control unit is further configured to detect the anniversary information input from the user and generate XHTML data including the detected anniversary information.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a flowchart of a method of outputting a calendar using a mobile device according to an example embodiment of the present invention;

FIG. 2 is a flowchart of an example transmission of XHTML-print data to an image forming device, shown in FIG. 1;

FIG. 3 is a flowchart of an example layout of setting information, shown in FIG. 2;

FIG. 4 is a table illustrating an example conversation window for outputting the calendar;

FIGS. 5A through 5F are tables illustrating conversation windows for inputting layout setting information according to an example embodiment of the present invention;

FIGS. 6A through 6D are tables illustrating conversation windows including layout setting information according to an example embodiment of the present invention;

FIG. 7 is a table illustrating a conversation window for registering anniversary information according to an example embodiment of the present invention;

FIG. 8 is a table illustrating a conversation window for storing the anniversary information according to an example embodiment of the present invention;

FIG. 9 is a table illustrating XHTML-Print templates corresponding to layout setting information according to an example embodiment of the present invention;

FIG. 10 illustrates a detected XHTML-Print template according to an example embodiment of the present invention;

FIG. 11 illustrates an image of a calendar output by the XHTML-Print template illustrated in FIG. 10;

FIG. 12 is a table storing national holiday information according to an example embodiment of the present invention;

FIG. 13 illustrates XHTML-Print data generated using a detected XHTML-Print template according to an example embodiment of the present invention;

FIG. 14 illustrates an example of XHTML-Print data according to an embodiment of the present invention;

FIG. 15 illustrates an image of a calendar output using the XHTML-Print data illustrated in FIG. 14;

FIG. 16 illustrates another example of XHTML-Print data according to another embodiment of the present invention;

FIG. 17 illustrates an image of a calendar output using the XHTML-Print data illustrated in FIG. 16;

FIG. 18 illustrates an image of a calendar output using XHTML-Print data according to an example embodiment of the present invention; and

FIG. 19 is a block diagram illustrating a calendar output system using a mobile device according to an example embodiment of the present invention.

### DETAILED DESCRIPTION OF THE EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An XHTML-Print document described below can be applied to an XHTML document or a Markup document having a different form.

A method and system for outputting a calendar according to the present invention will now be described more fully hereinafter with reference to the accompanying drawings, in which example embodiments of the invention are shown.

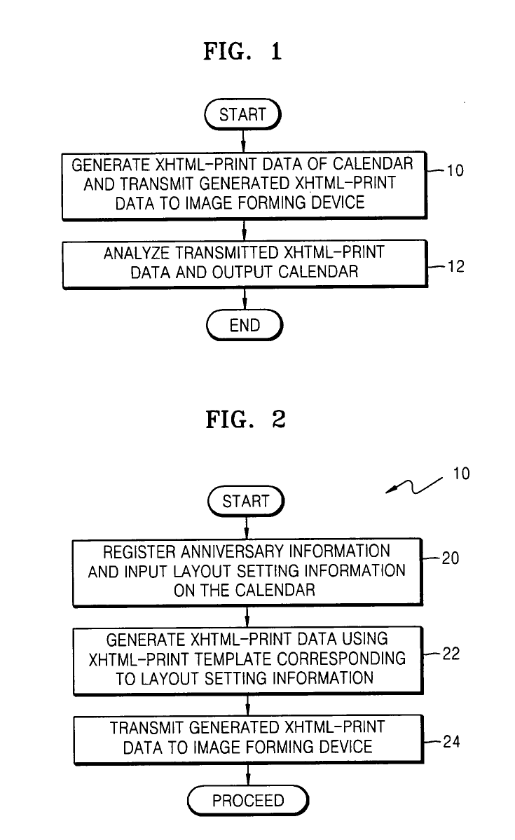

FIG. 1 illustrates a method of outputting a calendar by using a mobile device according to an example embodiment of the present invention. According to example embodiments of the present invention, the mobile device may correspond to a mobile phone, a personal digital assistant (PDA), or a portable device. An image forming device may correspond to a compact photo-printer or an image printer.

Referring to FIG. 1, an XHTML-Print template providing a layout is used at a mobile device to generate XHTML-Print data of the calendar and transmit the generated XHTML-Print data to an image forming device at block 10. Upon receipt of the transmitted XHTML-Print data, the image forming device analyzes the received XHTML-Print data and outputs a calendar at block 12.

FIG. 2 is a flowchart of an example transmission of XHTML-Print data at block 10, shown in FIG. 1. Referring to FIG. 2, layout setting information of the calendar is input at block 20. Such layout setting information may include at least one of country information, output size information, output kind information, output time information, anniversary output information, text output information, and insert image information. In addition to the layout setting information, anniversary information can additionally be registered at block 20. The anniversary information may include text information relating to the anniversary. The mobile device then generates XHTML-Print data using the XHTML-Print template corresponding to the layout setting information on the calendar at block 22, and then transmits the XHTML-Print data to the image forming device at block 24.

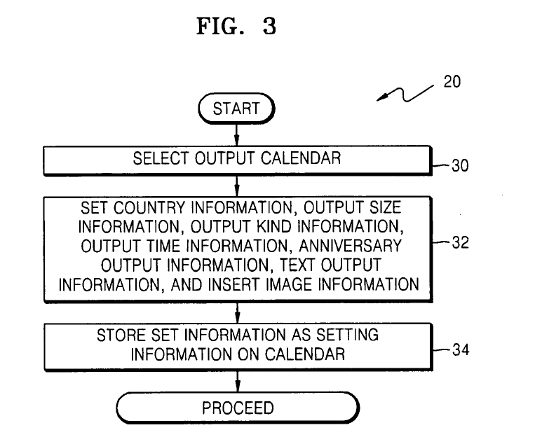

FIG. 3 is a flowchart of an example registration of anniversary information and an example input of layout setting information at block 20, shown in FIG. 2. Referring to FIG. 3, a calendar output is selected at block 30. Country information, output size information, output kind information, output time information, anniversary output information, text output information, and insert image information are designated at block 32.

The designated information is stored as the layout setting information of the calendar at block 34. The stored layout setting information is then used to generate the XHTML-Print data for outputting the calendar as shown in FIG. 2.

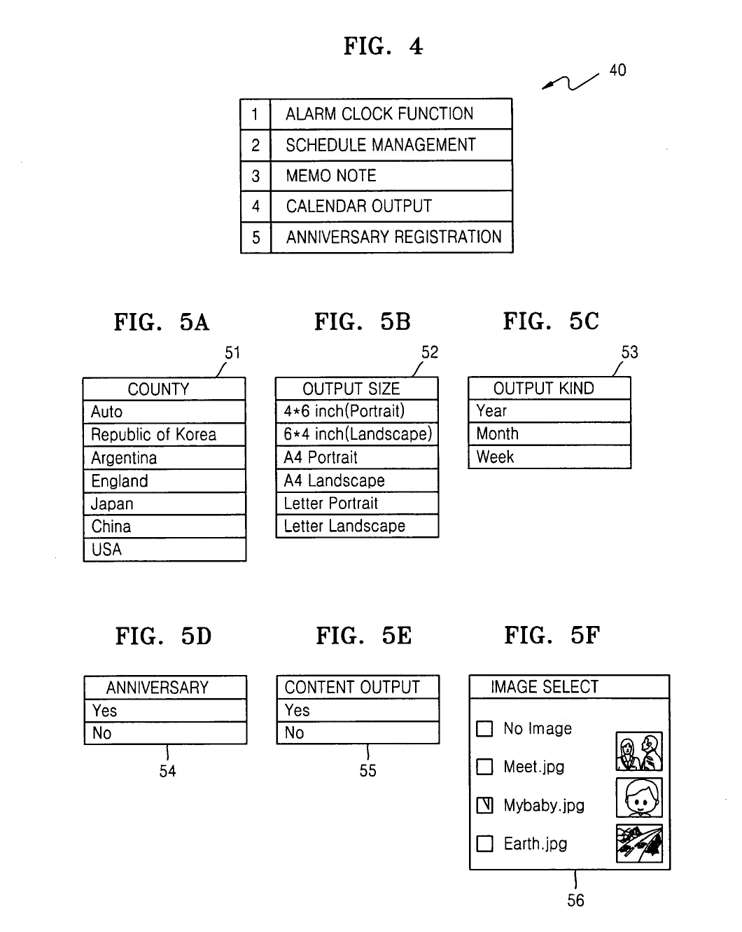

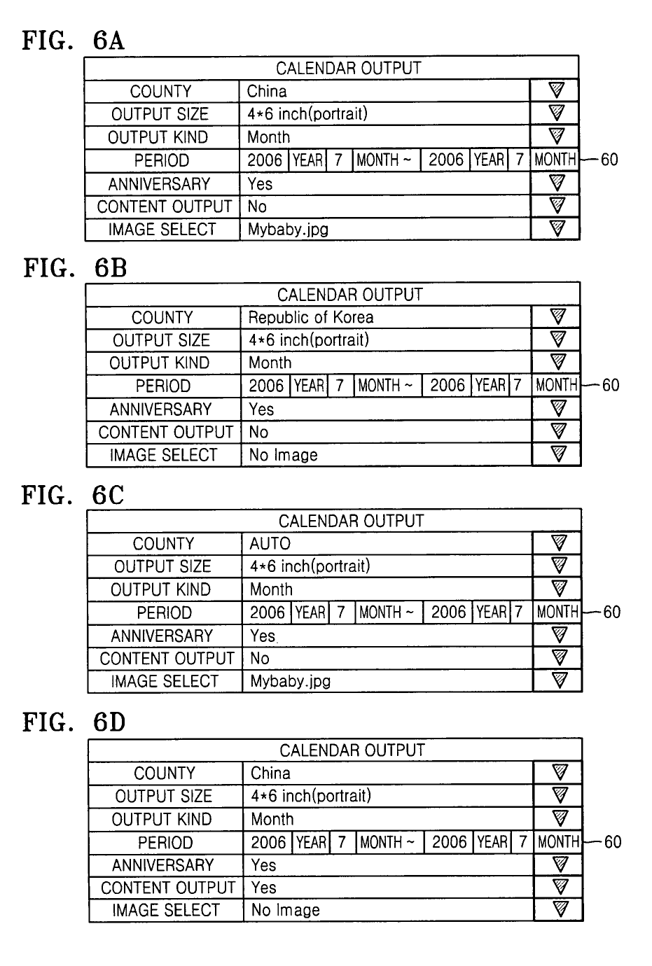

FIG. 4 is a table illustrating a conversation window for outputting the calendar according to an example embodiment of the present invention. FIGS. 5A through 5F are tables illustrating conversation windows for inputting layout setting information according to an example embodiment of the present invention.

Referring to FIG. 4, the conversation window 40 may include several menus, for example, menu #1 which indicates an alarm clock function, menu #2 which indicates a schedule management, menu #3 which indicates a memo note, menu #4 which indicates a calendar output, and menu #5 which indicates an anniversary registration. When the user selects a menu #4, which indicates a “calendar output”, the conversation window for inputting the layout setting information shown in FIG. 5 is displayed.

As previously discussed in connection to FIG. 2, the layout setting information 50 includes at least one of the country information 51, the output size information 52, the output kind information 53, the output time information, the anniversary output information, the text output information, and the insert image information.

Referring to FIG. 5A, a country corresponding to the calendar to be output can be set using this conversation window 51. In particular, when the user selects “Auto”, country code information set in a mobile device is used to automatically set information on the country. If the mobile device can communicate, the country code information used by the mobile device can be detected through an IP number or an identification number of a communication company of each country, and the country code information can be set as county information for outputting the calendar. Also, if the mobile device cannot communicate, country code information set in an operating system (OS) of the mobile device can be used to set the information on the country. Referring to FIG. 5B, an output size of the calendar can be set using this conversation window 52. Referring to FIG. 5C, a kind of the calendar, e.g., a calendar output by year, month, week, or day can be set using this conversation window 53. Referring to FIG. 5D, whether an anniversary is indicated in the calendar can be set using this conversation window 54. Referring to FIG. 5E, whether content, e.g., text information such as an anniversary, is indicated in the calendar can be set using this conversation window 55. Referring to FIG. 5F, whether an image (picture) is inserted in the calendar can be set through this conversation window 56.

FIGS. 6A through 6D are tables illustrating conversation windows 60 including layout setting information. Referring to FIG. 6A, the layout setting information indicates that an image is inserted into the calendar in the conversation window 60. Referring to FIG. 6B, the layout setting information indicates that the image is not inserted into the calendar in the conversation window 60. Referring to FIG. 6C, the layout setting information indicates that country information is automatically set as “AUTO” in the conversation window 60. Referring to FIG. 6D, the layout setting information indicates that the content output is included in the calendar in the conversation window 60.

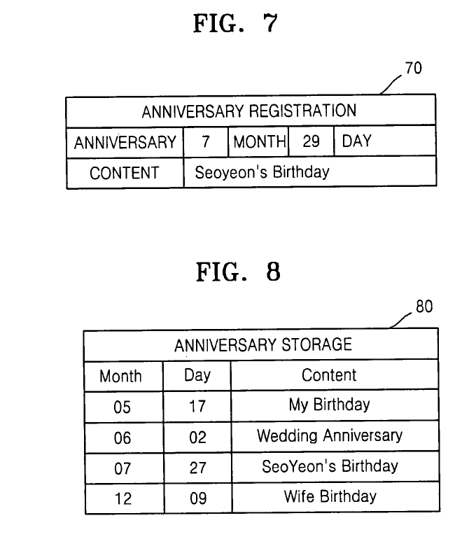

FIG. 7 is a table illustrating a conversation window for registering anniversary information according to an example embodiment of the present invention. The conversation window 70 may include anniversary information, such as the user's birthday information. Referring to FIG. 7, when the user selects menu #5 at the conversation window 40, shown in FIG. 4, for “anniversary registration”, the conversation window 70 for registering the anniversary information is displayed on the screen. When the user fills in a blank anniversary date and a blank content, the input information is registered as the anniversary information.

FIG. 8 is a table illustrating a conversation window for storing anniversary information according to an example embodiment of the present invention. Referring to FIG. 8, each kind of anniversary information input by the user is stored in the conversation window 80. For example, important birthdays of family members and wedding anniversary information may be stored in the conversation window 80.

Referring back to FIG. 2, after the anniversary information is registered and the layout setting information is input, the XHTML-Print template corresponding to the input layout setting information is detected in order to generate the XHTML-Print data including the input layout setting information at block 22.

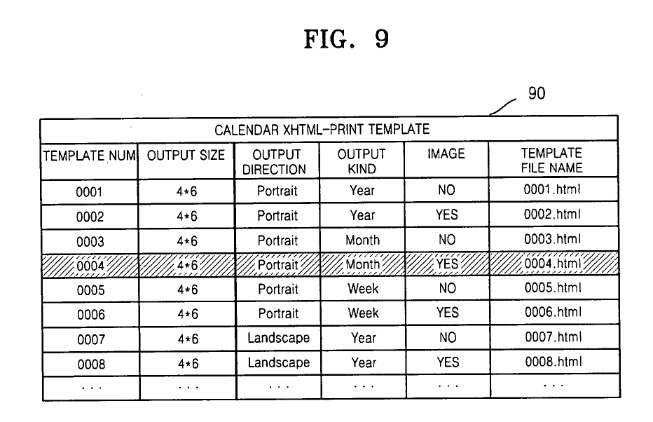

FIG. 9 is a table illustrating an example XHTML-Print template corresponding to layout setting information according to an embodiment of the present invention.

Referring to FIG. 9, an XHTML-Print template 90 corresponding to the layout setting information input at block 20, shown in FIG. 2, is detected from multiple XHTML-Print templates available for the mobile device. For example, if the layout setting information sets an output size as “4*6(Portrait)”, an output kind as “Month”, and an image insert as “YES”, an XHTML-Print template corresponding to a template number “0004” is detected from the XHTML-Print templates.

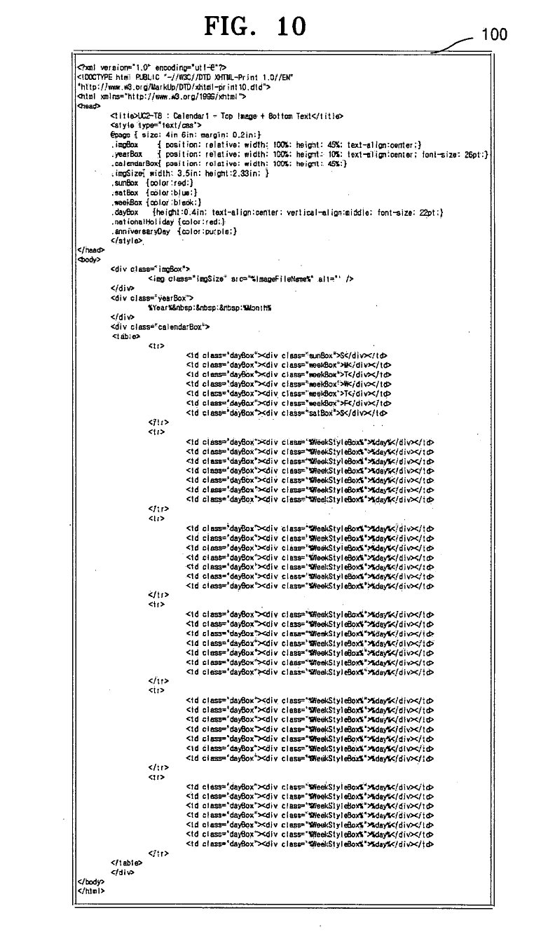

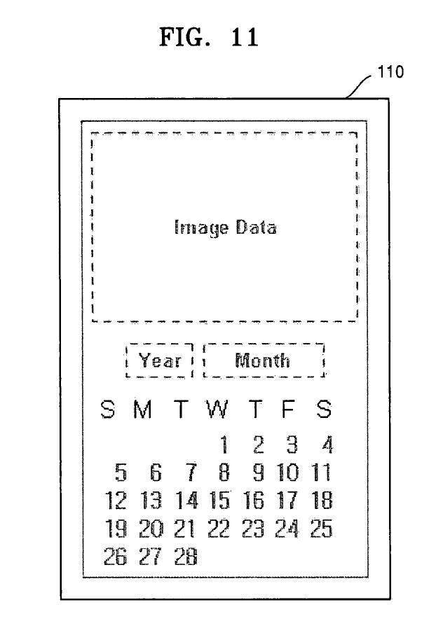

FIG. 10 illustrates an example detected XHTML-Print template according to an embodiment of the present invention. Referring to FIG. 10, the detected XHTML-Print template 100 corresponds to the layout setting information that sets an output size as “4*6(Portrait)”, an output kind as “Month”, and an image insert as “YES”.

FIG. 11 illustrates an example image of a calendar output 110 by the XHTML-Print template 100 shown in FIG. 10.

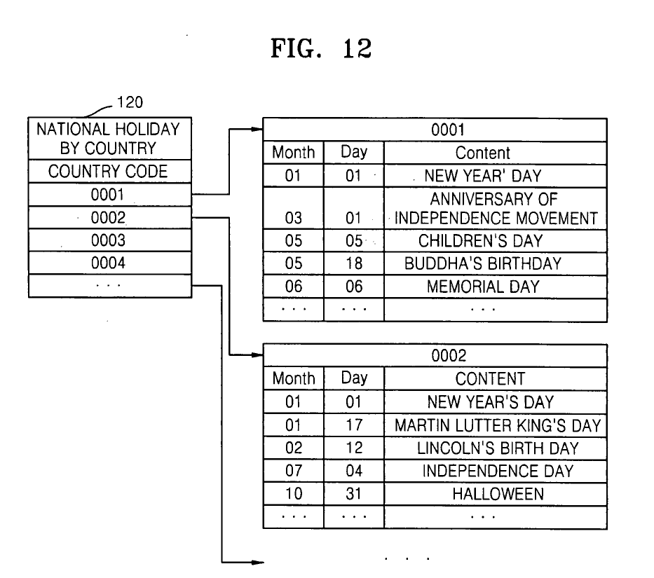

The national holiday information corresponding to the country information set at block 20, shown in FIG. 3, and the XHTML-Print data including the detected national holiday information is generated. FIG. 12 illustrates a table storing the national holiday information 120 according to an example embodiment of the present invention. Referring to FIG. 12, national holiday information corresponding to each country is stored in a predetermined memory. Therefore, if the country information set at block 20, shown in FIG. 3, is Korea, national holiday information corresponding to a country code of Korea “0001” is detected from a predetermined memory storing the national holiday information. The detected national holiday information is then used to generate the XHTML-Print data for outputting the calendar. The XHTML-Print data is generated to distinguish the detected national holiday information from other output information. The detected national holiday information is distinguished from other output information by making a color, a writing style, or a text size of the national holiday information different.

An insert image corresponding to the set insert image information is detected and the XHTML-Print data including the detected insert image is generated. The insert image set in the layout setting information is detected from a predetermined memory storing various kinds of image information, and the XHTML-Print data is generated to insert the detected insert image into the calendar.

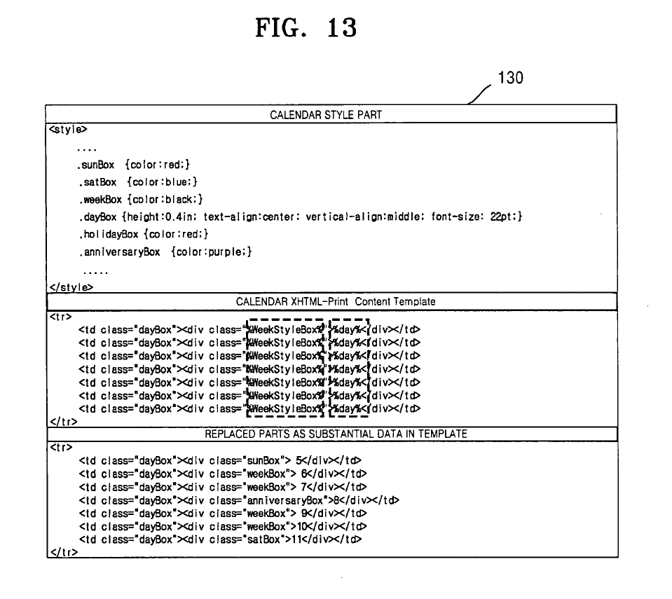

FIG. 13 illustrates XHTML-Print data generated using a detected XHTML-Print template according to an example embodiment of the present invention. Referring to FIG. 13, the XHTML-Print data includes a calendar style part, a calendar XHTML-Print content template, and replaced parts as substantial data in template. The “calendar style part” defines an anniversary, a weekend, and which style is applied to an anniversary date. Also, the calendar XHTML-Print Content Template defines a replacement as “% string %”, e.g., “% WeekStyleBox %”. The “% WeekStyleBox %” is replaced as a style according to the characteristic of a date of the “calendar style part”. For example, if the date is Sunday, the “% WeekStyleBox %” is replaced as “.sunBox”. If the date is an anniversary, the “% WeekStyleBox %” is replaced as “.anniversaryBox”. A font color of the anniversary is defined as a style of purple.

At block 22, shown in FIG. 2, the registered anniversary information is detected to generate the XHTML-Print data including the registered anniversary information. The XHTML-Print data is generated to distinguish the registered anniversary information from other output information.

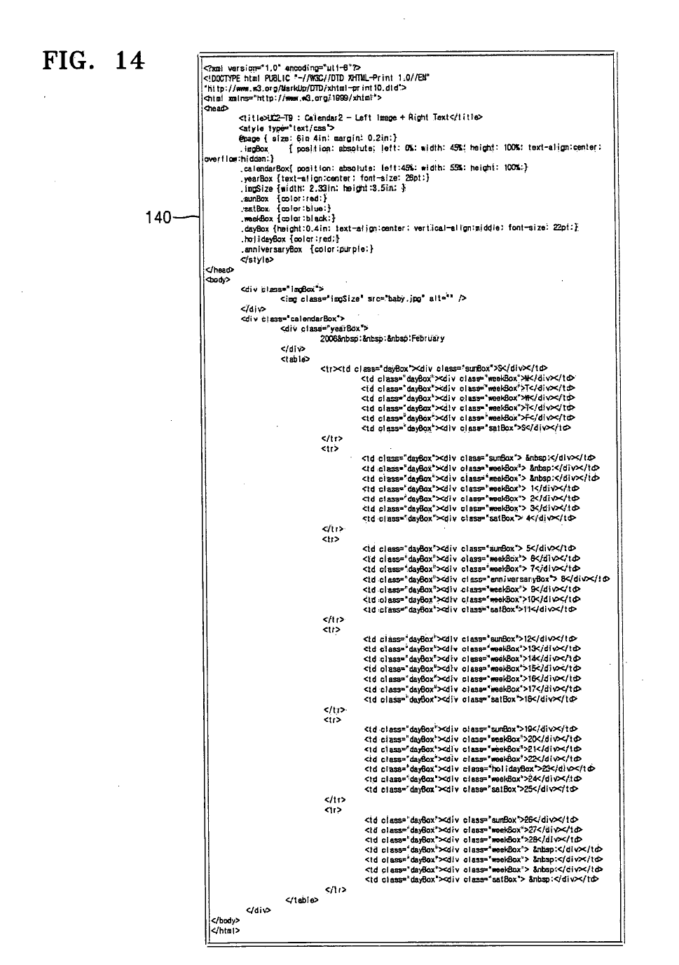

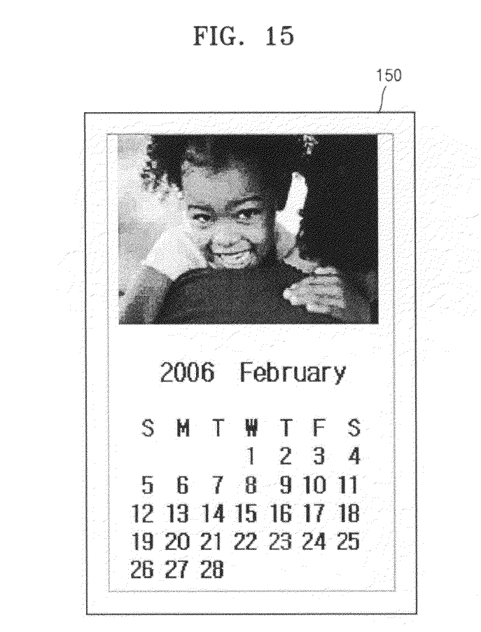

FIG. 14 illustrates an example of XHTML-Print data according to an embodiment of the present invention. Referring to FIG. 14, the XHTML-Print data 140 corresponds to layout setting information that sets an output size as “4&6(Portrait)”, an output kind as “Month”, an output period as “February 2006˜February 2006”, an anniversary as “Yes”, and an image insert as “Yes: MyBaby.jpg”. Bold characters are replaced using the layout setting information.

FIG. 15 illustrates an example image of a calendar output 150 using the XHTML-Print data shown in FIG. 14. Referring to FIG. 15, January 8 is an anniversary to which a style of purple is applied. Since February 28 is a national holiday, a style of red is applied to that date, which is distinguished from other dates.

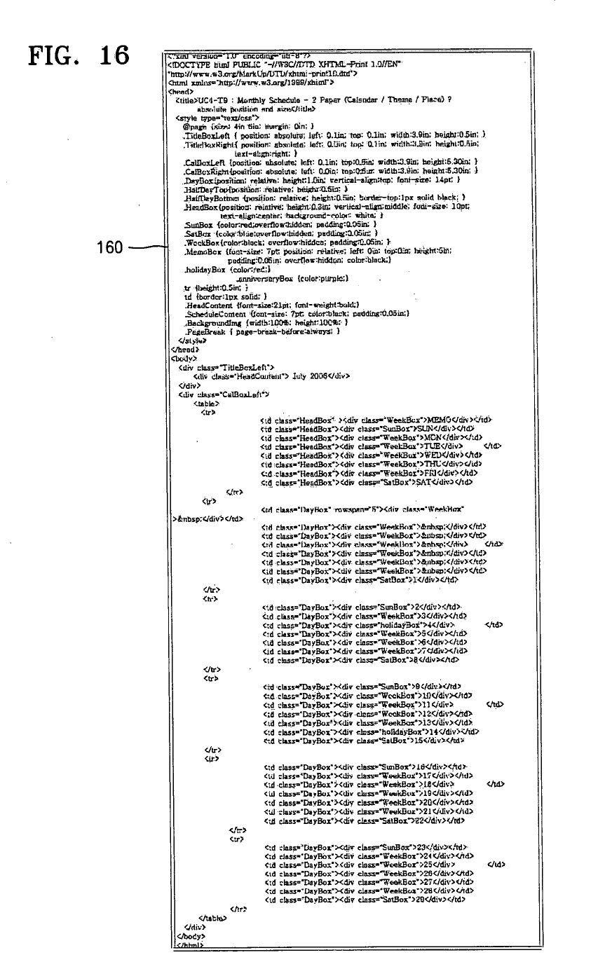

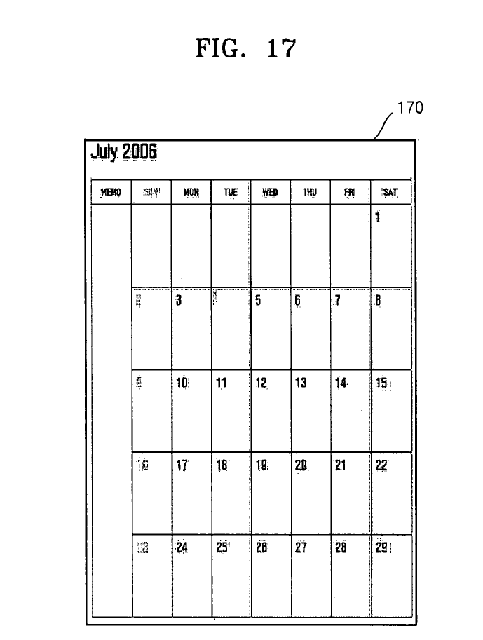

FIG. 16 illustrates another example of XHTML-Print data according to an embodiment of the present invention. Referring to FIG. 16, the XHTML-Print data 160 indicates that an output size is “portrait” and no image is inserted. FIG. 17 illustrates an example image of a calendar output 170 using the XHTML-Print data shown in FIG. 16.

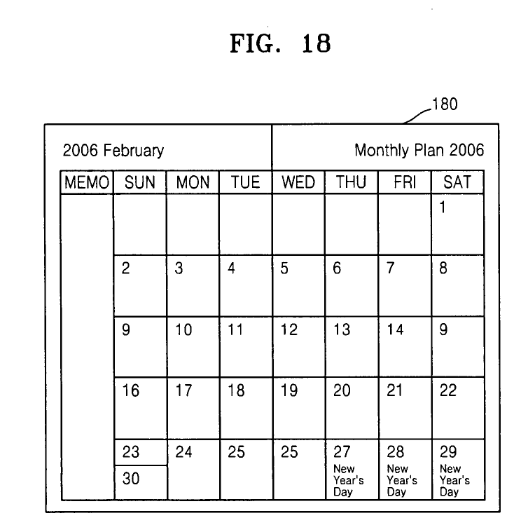

FIG. 18 illustrates an example image of a calendar output using XHTML-Print data according to an embodiment of the present invention. Referring to FIG. 18, the calendar 180 including content information about an anniversary and a national holiday is output.

After block 22, shown in FIG. 2, is performed, the generated XHTML-Print data is transmitted to the image forming device at block 24. The XHTML-Print data is transmitted to the image forming device connected to the mobile device over a transmission link, or a network.

Referring back to FIG. 1, after block 10 is performed, the transmitted XHTML-Print data is analyzed to output the calendar at block 12. The image forming device receives the XHTML-Print data regarding the calendar from the mobile device, analyzes the received XHTML-Print data, and prints the analyzed result using a printing engine of an image forming device.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion. Also, functional programs, code and code segments for accomplishing the present invention can be easily construed by programmer skilled in the art to which the present invention pertains.

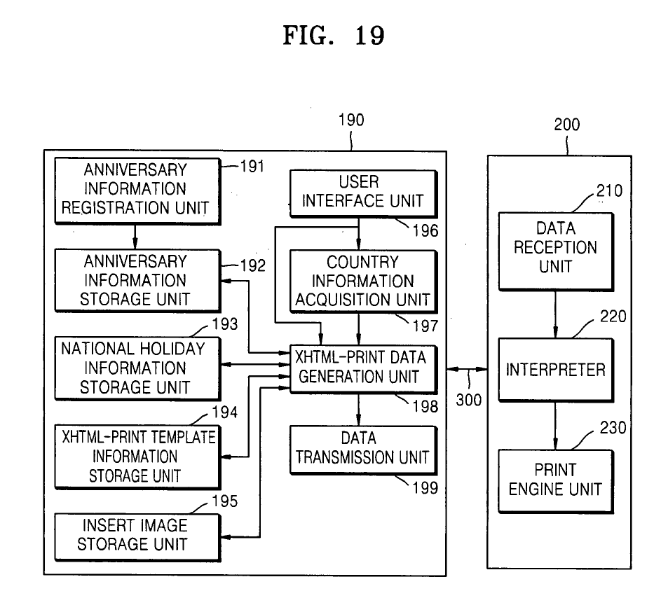

FIG. 19 is a block diagram illustrating an example calendar output system using a mobile device 190 according to an example embodiment of the present invention. The calendar output system comprises a mobile device 190, such as a mobile phone, and an image forming device 200, such as a home printer. The mobile device 190 generates XHTML-Print data of a calendar by using an XHTML-Print data template which defines a layout of the calendar and transmits the generated XHTML-Print data to the image forming device 200, via a transmission link 300. Such a transmission link 300 may utilize existing and accepted connectivity standards, including, for example: Bluetooth, IrDA and Wi-Fi for a wireless solution; PictBridge as a wired solution; and printing directly from memory cards.

The mobile device 190 comprises an anniversary information registration unit 191, an anniversary information storage unit 192, a national holiday information storage unit 193, an XHTML-Print template information storage unit 194, an insert image storage unit 195, a user interface unit 196, a country information acquisition unit 197, an XHTML-Print data generation unit 198, and a data transmission unit 199 to generate the XHTML-Print data of the calendar.

The anniversary information registration unit 191 registers anniversary information input by a user and transmits the registered anniversary information to the anniversary information storage unit 192. The anniversary information registration unit 191 can register text information relating to an anniversary as the anniversary information.

The anniversary information storage unit 192 receives and stores the registered anniversary information and transmits the anniversary information to the XHTML-Print data generation unit 198 at the request of the XHTML-Print data generation unit 198. The anniversary information storage unit 192 stores each kind of anniversary information registered by the anniversary information registration unit 191.

The national holiday information storage unit 193 stores national holiday information of each country and transmits national holiday information corresponding to country information from among layout setting information to the XHTML-Print data generation unit 198 at the request of the XHTML-Print data generation unit 198. An example of the national holiday information is shown in FIG. 12.

The XHTML-Print template information storage unit 194 stores XHTML-Print template information corresponding to various layouts and transmits an XHTML-Print template corresponding to the layout setting information to the XHTML-Print data generation unit 198 at the request of the XHTML-Print data generation unit 198. An example of XHTML-Print templates stored in the XHTML-Print template information storage unit 194 is shown in FIG. 8.

The insert image storage unit 195 stores images to be inserted into the calendar and transmits an insert image from among the layout setting information to the XHTML-Print data generation unit 198 at the request of the XHTML-Print data generation unit 198.

The user interface unit 196 receives the layout setting information on the calendar, and transmits a result of the received layout setting information to the country information acquisition unit 197 or the XHTML-Print data generation unit 198. The layout setting information includes at least one of country information, output size information, output kind information, output time information, anniversary output information, text output information, and insert image information.

The user interface unit 196 displays the conversation windows shown, for example, in FIGS. 5A-5F, and receives the layout setting information including the country information, the output size information, the output kind information, the output time information, the anniversary output information, the text output information, and the insert image information through the displayed conversation windows.

The country information acquisition unit 197 acquires the country information from country code information set in a mobile device 190 and transmits the acquired country information to the XHTML-Print data generation unit 198. If the country information is set as “Auto” among the layout setting information, the country information acquisition unit 197 can detect the country code information used by the mobile device 190 by using an IP number or an identification number of a communication company of each country, and set the country code information as the country information for outputting the calendar. If the mobile device 190 cannot perform the communication for detecting the country code information, the country information acquisition unit 197 can set the country information using the country code information set in an operating system (OS) of the mobile device 190.

The XHTML-Print data generation unit 198 detects the national holiday information corresponding to the country information from the national holiday information storage unit 193, and generates the XHTML-Print data including the national holiday information detected from the XHTML-Print data template.

The XHTML-Print data generation unit 198 detects an insert image corresponding to the insert image information from the insert image storage unit 195 and generates the XHTML-Print data including the insert image detected from the XHTML-Print data template.

The XHTML-Print data generation unit 198 detects the anniversary information stored in the anniversary information storage unit 192 and generates the XHTML-Print data including the anniversary information detected from the XHTML-Print data template. The XHTML-Print data generation unit 198 generates the XHTML-Print data to distinguish the registered anniversary information from other output information. The detected national holiday information is distinguished from other output information by making a color, a writing style, or a text size of the national holiday information different.

The data transmission unit 199 transmits the generated XHTML-Print data to the image forming device 200.

The image forming device 200 analyzes the XHTML-Print data transmitted from the device 190 and outputs the calendar. To this end, the image forming device 200 comprises a data reception unit 210, an interpreter 220, and a print engine unit 230.

The data reception unit 210 receives the XHTML-Print data transmitted from the mobile device 190 and transmits the received XHTML-Print data to the interpreter 220.

The interpreter 200 analyzes the received XHTML-Print data and transmits the analyzed result to the print engine unit 230.

The print engine unit 230 prints the analyzed XHTML-Print data.

According to the method and system for outputting a calendar by using a device according to the present invention, a user can easily output the calendar by using a Markup language such as XHTML-Print data capable of designating a style and generate the calendar by distinguishing a national holiday of each country and an anniversary defined by the user from the other dates, thereby easily recognizing a specific date.

Various components of the mobile device 190 and the image forming device 200, as shown in FIG. 19, can be integrated into a single control unit, or alternatively, can be implemented in software or hardware, such as, for example, an application specific integrated circuit (ASIC). For example, the anniversary information storage unit 192, the national holiday information storage unit 193, the XHTML-Print template information storage unit 194, the insert image storage unit 195 of the mobile device 190 can be implemented by a single storage unit. The anniversary information registration unit 191, the country information acquisition unit 197 and the XHTML-Print data generation unit 198 can be integrated into a single control unit, or alternatively, implemented as functions of an operating system (OS) of the mobile device 190. Similarly, the interpreter 220 can be integrated into an operating system (OS) of the image forming device 200. As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media. Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A method of outputting a calendar by using a mobile device, the method comprising:
generating, at the mobile device, XHTML data of the calendar by using XHTML templates defining a layout of the calendar and transmitting the XHTML data to an image forming device, via a transmission link; and
analyzing, at the image forming device, the transmitted XHTML data and outputting the calendar.

2. The method according to claim 1, further comprising:
receiving layout setting information about the calendar; and
detecting an XHTML template corresponding to the layout setting information and generating the XHTML data corresponding to the received layout setting information before transmission to the image forming device, via the transmission link.

3. The method according to claim 2, wherein the layout setting information includes at least one of country information, output size information, output kind information, output time information, anniversary output information, text output information, and insert image information.

4. The method according to claim 3, further comprising:
selecting to output the calendar;
setting the country information, the output size information, the output kind information, the output time information, the anniversary output information, the text output information, and the insert image information; and
storing the information as layout setting information of the calendar.

5. The method according to claim 3, wherein the country information is automatically set using country code information set in the mobile device.

6. The method according to claim 3, wherein the generating of the XHTML data comprises:
detecting national holiday information corresponding to the country information; and
generating XHTML data including the detected national holiday information.

7. The method according to claim 6, wherein the generating of the XHTML data comprises:
distinguishing the detected national holiday information from other output information of the calendar.

8. The method according to claim 3, wherein the generating of the XHTML data comprises:
detecting an insert image corresponding to the insert image information; and
generating XHTML data including the detected insert image.

9. The method according to claim 2, further comprising:
registering anniversary information; detecting the registered anniversary information; and
generating XHTML data including the detected anniversary information.

10. The method according to claim 9, wherein text information relating to the anniversary is included as the registered anniversary information.

11. The method according to claim 10, wherein the generating of the XHTML data comprises: distinguishing the detected anniversary information from other output information of the calendar.

12. A computer readable recording medium storing a program executing a method according to claim 1.

13. A system for outputting a calendar by using a mobile device, the system comprising:
a mobile device arranged to generate XHTML data of the calendar by using XHTML templates defining a layout of the calendar; and
an image forming device coupled to receive and analyze the XHTML data transmitted from the mobile device, and to output the calendar.

14. The system according to claim 13, wherein the mobile device comprises:
a national holiday storage unit to store national holiday information of each country;
an XHTML template information storage unit to store XHTML template information corresponding to various layouts;
a user interface unit arranged to receive layout setting information about the calendar;
an XHTML data generation unit to detect an XHTML template corresponding to the received layout setting information and generate XHTML data corresponding to the received layout setting information; and
a data transmission unit arranged to transmit the generated XHTML data to the image forming device, via a transmission link.

15. The system according to claim 14, wherein the layout setting information includes at least one of country information, output size information, output kind information, output time information, anniversary output information, text output information, and insert image information.

16. The system according to claim 15, further comprising:
a country information acquisition unit arranged to acquire the country information from country code information set in the mobile device.

17. The system according to claim 15, wherein the XHTML data generation unit detects national holiday information corresponding to the country information from the national holiday information storage unit, and generates XHTML data including the detected national holiday information.

18. The system according to claim 15, further comprising:
an insert image storage unit to store images to be inserted into the calendar,
wherein the XHTML data generation unit detects an insert image corresponding to the insert image information from the insert image storage unit, and generates XHTML data including the detected insert image.

19. The system according to claim 14, further comprising:
an anniversary information registration unit arranged to register anniversary information; and
an anniversary information storage unit to store the registered anniversary information,
wherein the XHTML data generation unit detects the registered anniversary information from the anniversary information storage unit, and generates XHTML data including the detected anniversary information.

20. The system according to claim 19, wherein the XHTML data generation unit generates the XHTML data to distinguish the registered anniversary information from other output information of the calendar.

21. A mobile device for generating a calendar comprising:
a storage unit arranged to store anniversary information input by a user, national holiday information of each country, XHTML-print template information corresponding to various layouts; and images to be inserted into the calendar;
a user interface unit arranged to receive layout setting information about the calendar; and
a control unit configured to detect an XHTML template corresponding to received layout setting information, to generate XHTML data of the calendar corresponding to the received layout setting information, and to transmit the XHTML data to an image forming device, via a transmission link.

22. The mobile device according to claim 21, wherein the image forming device is coupled to receive and analyze the XHTML data transmitted from the mobile device, so as to output and print the calendar.

23. The mobile device according to claim 21, wherein the storage unit comprises:
a national holiday storage unit to store national holiday information of each country;
an XHTML template information storage unit to store XHTML template information corresponding to various layouts;
an insert image storage unit to store images to be inserted into the calendar,
wherein the control unit is further configured to detect an insert image corresponding to the insert image information from the insert image storage unit, and generate XHTML data including the detected insert image.

24. The mobile device according to claim 21, wherein the layout setting information includes at least one of country information, output size information, output kind information, output time information, anniversary output information, text output information, and insert image information.

25. The mobile device according to claim 21, wherein the control unit is further configured to acquire the country information from country code information set in the mobile device, to detect national holiday information corresponding to the country information, and to generate XHTML data including the detected national holiday information.

26. The mobile device according to claim 21, wherein the control unit is further configured to detect the anniversary information input from the user and generate XHTML data including the detected anniversary information.

27. The mobile device according to claim 21, wherein the control unit is further configured to detect the anniversary information input from the user and to generate XHTML data to distinguish the anniversary information from other output information of the calendar.
